(19) United States
(12) Patent Application Publication
(10) Pub. No.: US 2016/0132889 A1
(43) Pub. Date: May 12, 2016

(54) SYSTEM AND METHOD FOR PAYER CONTROLLED PAYMENT PROCESSING SYSTEM

(71) Applicant: GOVINDARAJ SETLUR, CUPERTINO, CA (US)

(72) Inventor: GOVINDARAJ SETLUR, CUPERTINO, CA (US)

(21) Appl. No.: 14/194,668

(22) Filed: Mar. 1, 2014

(51) Int. Cl. G06Q 20/40

(52) U.S. Cl. CPC G06Q 20/4097

(57) ABSTRACT

Methods, systems, and computer programs for processing payment request for a payment instrument. The method includes setting issuer attributes for the payment instrument and setting payer attribute for the payment instrument. A request for payment approval is received. The request is verified against payer set attributes. The request is also verified against issuer set attributes. An approval message is generated when payment request matches both payer set attributes and issuer set attributes.

### CLAIM OF PRIORITY

None.

### BACKGROUND

1. Field of the Invention

The present invention relates to methods and system for payer controlled payment system, and more particularly, methods, systems, and computer programs for providing selective payer controlled payment transactions.

2. Description of the Related Art

Payment processing systems are based on various inter-linked systems and networks. For example, payment systems may be based on a payment instrument, for example, a credit card or a debit card. Some debit systems may be configured as a pre-paid debit card, with a pre-defined available balance. Some debit card systems may be configured as a pre-paid gift card, with a pre-defined available balance. Payment instruments are issued to a payer or a payment instrument holder, by an issuer. In some examples, an issuer may be a banking or financial institution.

In general, there are multiple systems that communicate with each other, to complete a payment transaction for a payment instrument. Each payment transaction generally includes an authorization cycle and a settlement cycle. Authorization cycle is initiated to approve or disapprove a requested payment to a merchant based on a payment instrument presented by a payment instrument holder or a payer. A settlement cycle is initiated periodically to confirm conclusion of a payment transaction, so that approved payment amount may be paid to the merchant and approved payment amount is collected from the payer or the payment instrument holder.

As one skilled in the art appreciates, a limited time is allocated for completion of a payment transaction through multiple systems. These systems are designed to provide automated transaction approval. Additionally, risk of loss due to improper approval of a payment transaction for a payment instrument is allocated to the merchant who receives the payment instrument information or an issuer who issues the payment instrument to a payer, depending upon certain predefined criteria. Although there are various levels of control to prevent data breach, information related to a payment instrument may be acquired by unscrupulous personnel. It is not uncommon for these unscrupulous personnel to improperly use the information related to a payment instrument in a transaction.

It may be advantageous to provide for improved systems and methods for payer controlled payment processing system. It is in this context that embodiments of this disclosure arise.

### SUMMARY

Embodiments of the present invention provide methods, systems, and computer programs for payer controlled payment processing system. In one embodiment, a method for processing payment request for a payment instrument is disclosed. The method includes setting issuer attributes for the payment instrument and setting payer attribute for the payment instrument. A request for payment approval is received. The request is verified against payer set attributes. The request is also verified against issuer set attributes. An approval message is generated if payment request matches both payer set attributes and issuer set attributes.

In another embodiment, a system to process payment request for a payment instrument is disclosed. The system includes a card management system to set issuer attributes for the payment instrument in a CMS data store. The system also includes a payer controlled module to set payer attributes for the payment instrument in a PCM data store. The system receives a request for payment approval. The payer controlled module verifies request against payer set attributes. The card management system verifies request against issuer set attributes. The card management system generates an approval message if payment request matches both payer set attributes and issuer set attributes.

In another embodiment, a non-transitory computer readable medium having program instructions, which when executed by a computing device implements a method for an access control system.

The present disclosure is now described in detail with reference to a few embodiments thereof as illustrated in the accompanying drawings. In the following description, numerous specific details are set forth in order to provide a thorough understanding of the present disclosure. It is apparent, however, to one skilled in the art, that the present disclosure may be practiced without some or all of these specific details. In other instances, well known process operations and structures have not been described in detail in order not to unnecessarily obscure the present disclosure. In addition, while the disclosure is described in conjunction with the particular embodiments, it should be understood that this description is not intended to limit the disclosure to the described embodiments. To the contrary, the description is intended to cover alternatives, modifications, and equivalents as may be included within the spirit and scope of the disclosure as defined by the appended claims.

### BRIEF DESCRIPTION OF THE DRAWINGS

The invention may best be understood by reference to the following description taken in conjunction with the accompanying drawings.

FIG. 1 illustrates a block diagram of the payment instrument processing system, in one example of this disclosure.

FIG. 2 illustrates an example block diagram of the payer controlled module, the CMS and payer computer of payment instrument processing system of FIG. 1, in one example of this disclosure.

FIG. 2A illustrates an example issuer table, in one example of this disclosure.

FIG. 2B illustrates an example payer table, in one example of this disclosure.

FIG. 3 illustrates an example payment transaction information packet, in one example of this disclosure.

FIG. 4 illustrates a flow diagram showing example processing of a payment for a payment instrument, in one example of this disclosure.

FIG. 5 illustrate an exemplary network environment suitable for implementing an example payment instrument processing system, in one example of this disclosure.

FIG. 5A illustrates computing device architecture of a computing device for use in the exemplary network environment of FIG. 5.

FIG. 6 illustrates an example payer computer, in one example of this disclosure.

FIG. 6A illustrates a table with various payment instrument status indicator displayed on the payer computer of FIG. 6.

### DETAILED DESCRIPTION

The following embodiments describe methods, systems, and computer programs for payer controlled payment processing system. It will be apparent, that the present embodiments may be practiced without some or all of these specific details. In other instances, well known process operations have not been described in detail in order not to unnecessarily obscure the present embodiments.

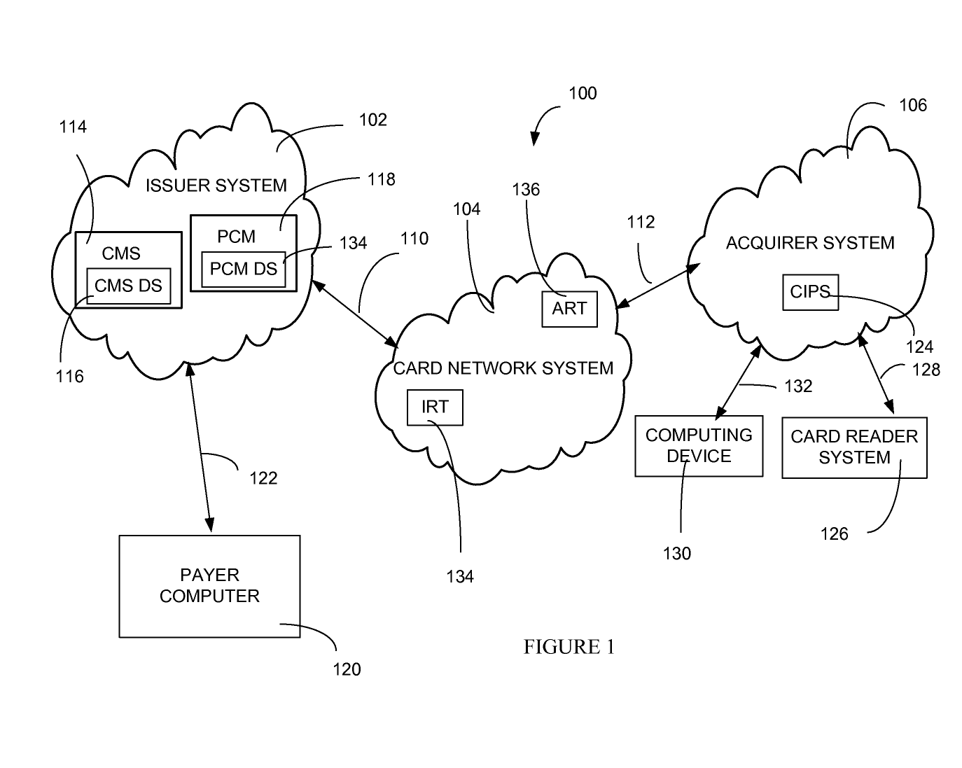

Now, referring to FIG. 1, a payment instrument processing system 100 will be described. The payment instrument processing system 100 includes an issuer system 102, a card network system 104 and an acquirer system 106. The issuer system 102 communicates with the card network system 104 over link 108. The card network system 104 communicates with the acquirer system 106 over link 110.

The issuer system 102 may be part of a bank or a financial institution system that issues a payment instrument to a payer. The payment instrument may be based on a specific instrument network system. Some of the well known card network systems are card systems based on VISA®, MasterCard®, Discover® and American Express® card network system. The issuer system 102 may further include a card management system 114. Card management system 114 may be sometimes referred to as a CMS 114. CMS 114 further includes a CMS data store 116.

When an issuer, issues a payment instrument to a payer, various information related to the payment instrument and the payer is stored in the CMS data store 116. Some of the information stored in the CMS data store 116 may be, name of the payer, address of the payer, contact information for the payer, payment instrument identification number, expiration date of the payment instrument, amount of available funds on the payment instrument. The CMS data store 116 may also store one or more additional identification number, specifically issued to the payment instrument. Some of the information stored in the CMS data store 116 may be physically printed on the payment instrument. The issuer system 102 further includes a payer controlled module 118. The payer controlled module 118 is configured to communicate with a payer computer 120 over link 122. Functions and features of payer controlled module 118 will be later described in detail.

An acquirer system 106 may be a card processing system run by one or more acquirers. Sometimes, acquirers may be banking institutions. The acquirer system 106 includes a card information processing system 124, which may be sometimes referred to as a CIPS 124. The CIPS 124 is configured to communicate with a card reader device 126, over a link 128. In general, an acquirer provides a card reader device 126 at a point of sale location, for example, to a merchant, to receive information stored in a payment instrument. These types of transactions are referred to as a card present (CP) transactions.

In some examples, information related to the payment instrument may be entered into a computer, for example, in a payment screen of a web application. For example, in some examples, the CIPS 124 may be configured to present a payment screen on a computing device 130, over a link 132, to receive information related to the payment instrument. These types of transactions are referred to as a card not present (CNP) transactions. CP transactions and CNP transactions may require entry of additional information, to validate the transaction. In some examples, entry of additional information is either physically present in the payment instrument or only known to the payer of the payment instrument.

The card network system 104 includes an issuer routing system 134 and an acquirer routing system 136. The issuer routing system 130 is configured to selectively communicate with the issuer system 102 over link 110, based on selective information stored in the payment instrument. The acquirer routing system 132 is configured to selectively communicate with an acquirer system 106 over link 112, based on selective identification information received from the acquirer system. As one skilled in the art appreciates, the card network system 104 acts as a transaction routing system to selectively route communication between an acquirer system 106 and a corresponding issuer system 102. An example payment transaction processing for a payment instrument will now be described.

Each payment transaction generally includes an authorization cycle and a settlement cycle. Authorization cycle is initiated to approve or disapprove a requested payment. A settlement cycle is initiated periodically to confirm conclusion of a payment transaction, so that acquirer can pay the approved payment amount to a merchant and issuer can bill a payer for the approved payment amount.

Authorization cycle is started when a payment instrument information is entered and submitted to the acquirer system 106. For example, a payment transaction information may include information related to the payment instrument along with the amount to be paid. The payment transaction information is received by the CIPS 124 of the acquirer system 106. CIPC 124 may receive payment transaction information from either a computing device 130, in a CNP transaction or from a card reader system 126 in a CP transaction. The acquirer system 106 decodes a portion of the payment transaction information to determine the corresponding card network the payment instrument belongs to. Based on the card network the payment instrument belongs to, the payment transaction information is transmitted to the corresponding card network system. For example, the payment transaction information is transmitted to card network system 104, over link 112. Now, the acquirer system 106 awaits for an approval or disapproval of the payment transaction from the card network system 104.

The card network system 104 decodes a portion of the payment transaction information to determine the specific card issuer and transmits the payment transaction information to the card issuer system. For example, the card network system 104 may decode a portion of the payment transaction information and determine the specific card issuer, by using the issuer routing system 134. In some examples, the issuer routing system 134 transmits the payment transaction information to the card issuer system 102, over link 110. Now, the card network system 104 awaits for an approval or disapproval of the payment transaction by the card issuer system 102.

Upon receipt of the payment transaction information, the card issuer system 102 determines if the requested payment should be approved, based on one or more pre-defined criteria. For example, the card issuer system 102 may use the CMS 114 to determine if the payment transaction should be approved or disapproved. For example, CMS 114 may check the credit limit established for the payment instrument and validation of the payment instrument identification information stored in the CMS data store 116. If there is a match, the CMS 114 may indicate to the card issuer system 102 to communicate an approval message. If there is no match, the CMS 114 may indicate to the card issuer system 102 to communicate a disapproval message.

The card issuer system 102 sends a return message to the card network system 104 either approving or disapproving the payment transaction. The card network system 104 in turn, forwards the return message of approval or disapproval to the acquirer system 106. For example, the card issuer system 102 may use the acquirer routing system 136 to determine the corresponding acquirer system to forward the return message.

The acquirer system 106 receives the return message over link 112. Upon receipt of the return message, based on the message content (approval or disapproval), the acquirer system 106 send a message to the card reader system 126 or the computing device 130 indicating the approval or disapproval of the transaction. For example, the CIPS 124 of the acquirer system 106 may communicate with the computing device 130 or the card reader system 126 to indicate the approval or disapproval of the transaction. This completes the approval cycle of the payment transaction.

A settlement cycle is initiated periodically to confirm conclusion of a payment transaction, so that approved payment amount may be paid to the merchant and approved payment amount is collected from the payer or the payment instrument holder. For example, settlement cycle may be run periodically, for example, at the end of the day. The acquirer system 106 compiles all the payment transactions that were approved and sends it to the card network system 104. The card network system 104 segregates all the payment transactions by its corresponding issuer system and sends specific completed payment transaction to the corresponding issuer system. Eventually, as part of the conclusion of the settlement cycle, each issuer pays the total approved amount owed to the corresponding acquirer. The acquirer pays its merchant, payment owed by the payer. And, the issuer collects the amount paid from the payer.

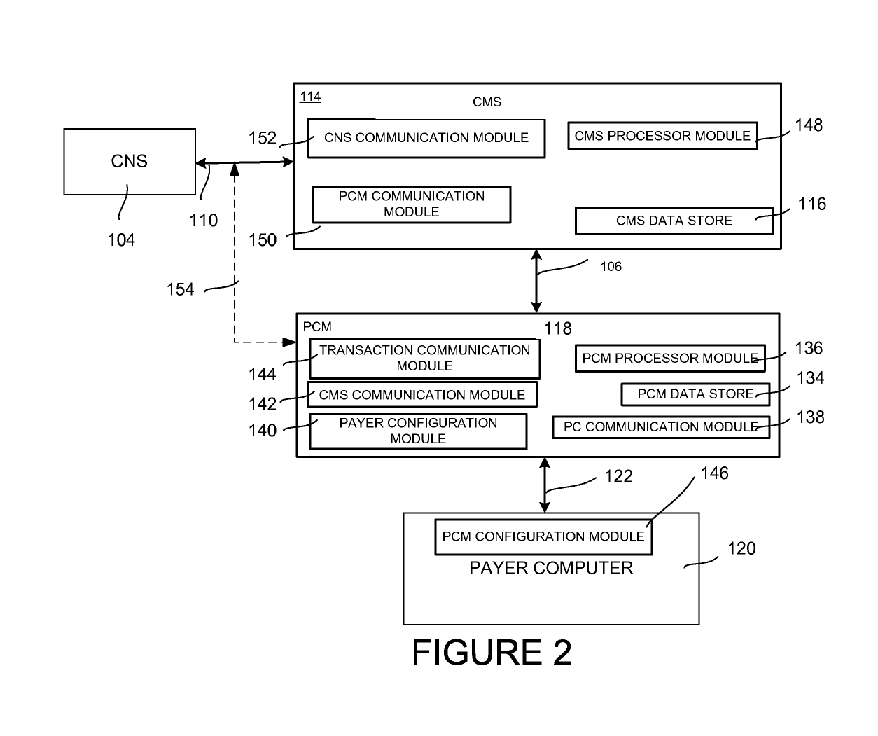

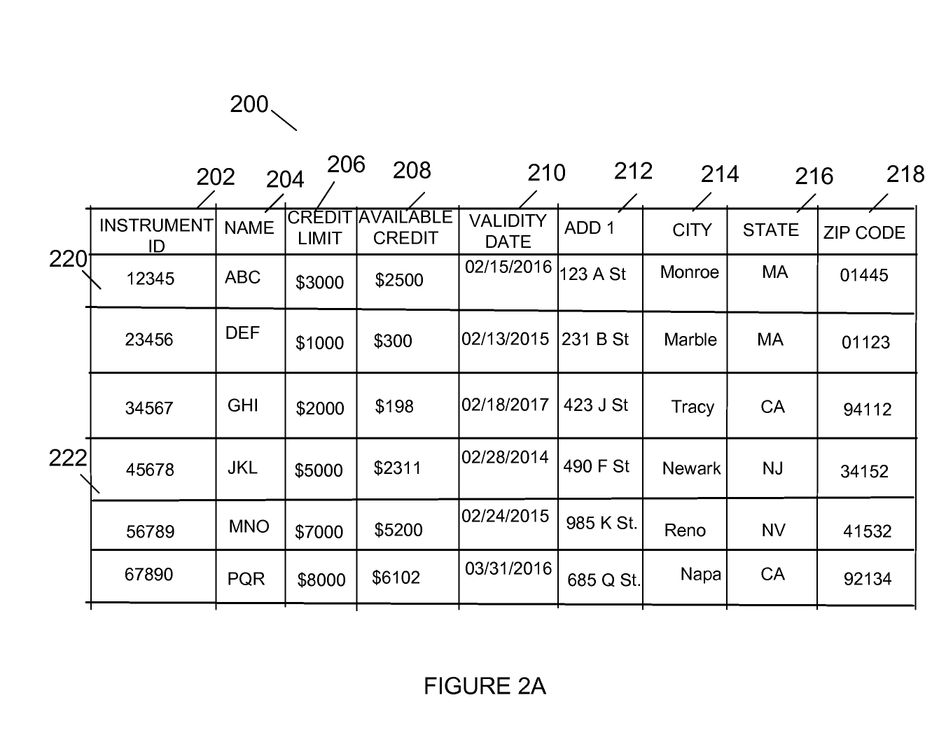

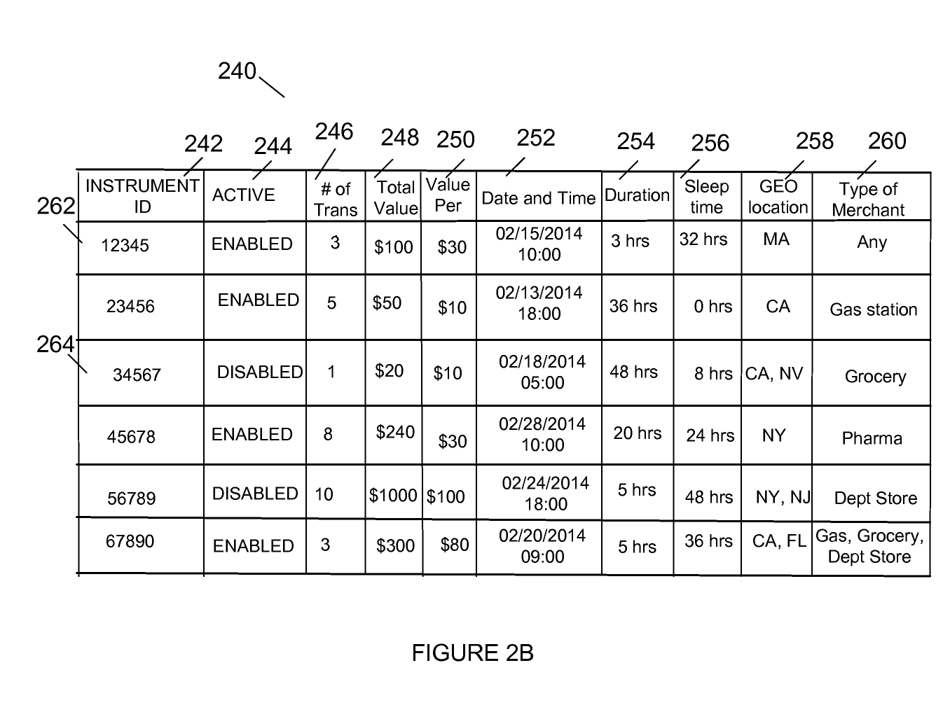

Having described an example payment transaction processing by the payment processing system 100, now the functions and features of the payer controlled module 118 will be described, with reference to FIG. 2.

FIG. 2 illustrates a block diagram of the payer controlled module 118, the CMS 114 and payer computer 120. As one skilled in the art appreciates, the payer controlled module 118 and CMS 114 may be implemented in hardware, software or a combination of hardware and software.

Payer controlled module 118 includes a PCM processor module 136, a PCM data store 134, a PC communication module 138, a payer configuration module 140, a CMS communication module 142 and a transaction communication module 144. The PCM processor module 136 performs various processing functions of the payer controlled module 118. PCM processor module 136 may be a hardware processor or a software processor configured to perform various arithmetic and logic functions. PCM data store 134 may be used to store and access various data values on a temporary or permanent basis.

PC communication module 138 may be configured to communicate with the payer computer 120. For example, the PC communication module 138 may be configured to communicate with a PCM configuration module 146 of the payer computer 120, over link 122. PC communication module 138 may also be configured to communicate with other functional modules of PCM 118. Payer configuration module 140 is configured to set various parameters of the payer controlled module 118, which will be described in detail with reference to FIG. 2B. For example, payer configuration module 140 may communicate with the payer computer using the PC communication module 138 to receive various inputs, for example, from a payer. Based on the received input, the payer configuration module 140 may store one or more parameters in the PCM data store. In some examples, payer configuration module 140 may communicate with the payer computer using the PC communication module 138 to present various input screens on the payer computer.

The CMS 114 may include a CMS processor module 148, CMS data store 116, PCM communication module 150 and CNS communication module 152. The CMS processor module 148 performs various processing functions of the CMS 114. CMS processor module 148 may be a hardware processor or a software processor configured to perform various arithmetic and logic functions. CMS data store 116 may be used to store and access various data values on a temporary or permanent basis. The PCM communication module 150 is configured to communicate with PCM 118, over link 106. For example, PCM communication module 150 may communicate with CMS communication module 142 of PCM 118. The CNS communication module 152 may be configured to communicate with CNS 104 over link 110. As one skilled in the art appreciates, CNS communication module 152 and PCM communication module 150 may be configured to communicate with other functional modules of CMS 114. In some examples, the CNS 104 may communicate with transaction communication module 144 of PCM 118 over link 154.

Now, referring to FIG. 2A, an example issuer table 200 that may be created and maintained by the issuer in the CMS 114 is described. The issuer table 200 may be stored in the CMS data store 116. Issuer table 200 maintains various attributes related to a payment instrument. For example, column 202 stores payment instrument identification number. Column 204 stores name of the payee. Column 206 stores credit limit of the payment instrument. Column 208 stores available credit for the payment instrument. Column 210 stores validity date for the payment instrument. Column 212 stores address of the payer. Column 214 stores city of the payer. Column 216 stores state of the payer. Column 218 stores zip code of the payer. As one skilled in the art appreciates, additional attributes related to the payer and the payment instrument may be stored in the issuer table 200.

Now, referring to row 220, for payment instrument identification of 12345, the name of the payer is ABC. The credit limit of the payment instrument 12345 is $3000. The available credit for the payment instrument 12345 is $2500. The validity date of the payment instrument 12345 is Feb. 15, 2016. The address of the payer is 123 A St. The city of the payee is Monroe, the state of the payee is MA and postal zip code of the payee is 01445. Similarly, referring to row 222, for payment instrument identification of 45678, the city of payee is Newark and postal zip code of payee is 34152.

Now, referring to FIG. 2B, an example payer table 240 that may be created and maintained by a payer in the PCM 118 is described. The payer table 240 may be stored in the PCM data store 134. Payer table 240 maintains various attributes related to a payment instrument, as set by the payer. For example, column 242 stores payment instrument identification number. Column 244 stores active status of the instrument, for example whether the payment instrument is enabled or disabled. Column 246 stores number of transactions permitted. Column 248 stores total value permitted for the transactions. Column 250 stores maximum value per transaction. Column 252 stores date and time the corresponding row was set by a payer. Column 254 stores duration the payment instrument should be active. Column 256 stores sleep time for the payment instrument. Column 258 stores the geographic location where the payment instrument can be used. Column 260 stores the type of merchants the payment instrument can be used. As one skilled in the art appreciates, additional attributes related to the payment instrument may be stored in the payer table 200 by the payer

Now, referring to row 262, for payment instrument identification of 12345, the active status of the instrument indicates that it is enabled. Permitted number of transactions are 3. Total value permitted for the transactions are $100. Maximum permitted value per transaction is $30. The date and time the payer for payment instrument identification number of 12345 set various attributes is Feb. 2, 2014 at 10:00 AM, as shown in column 252. The payment instrument will be active for 3 hrs, after a sleep time of 32 hours from the date and time shown in column 252. The geographic location where the payment instrument can be used is MA. The payment instrument may be used at any type of merchant.

Now referring to row 264, for payment instrument identification number 34567, the active status of the instrument indicates it is disabled. Now, referring to row 266, for payment instrument identification number 67890, the payment instrument may be used at any merchant who sells gas, grocery and at a department store.

The credit limit of the payment instrument 12345 is $3000. The available credit for the payment instrument 12345 is $2500. The validity date of the payment instrument 12345 is Feb. 15, 2016. The address of the payer is 123 A St. The city of the payee is Monroe, the state of the payee is MA and postal zip code of the payee is 01445. Similarly, referring to row 222, for payment instrument identification of 45678, the city of payee is Newark and postal zip code of payee is 34152.

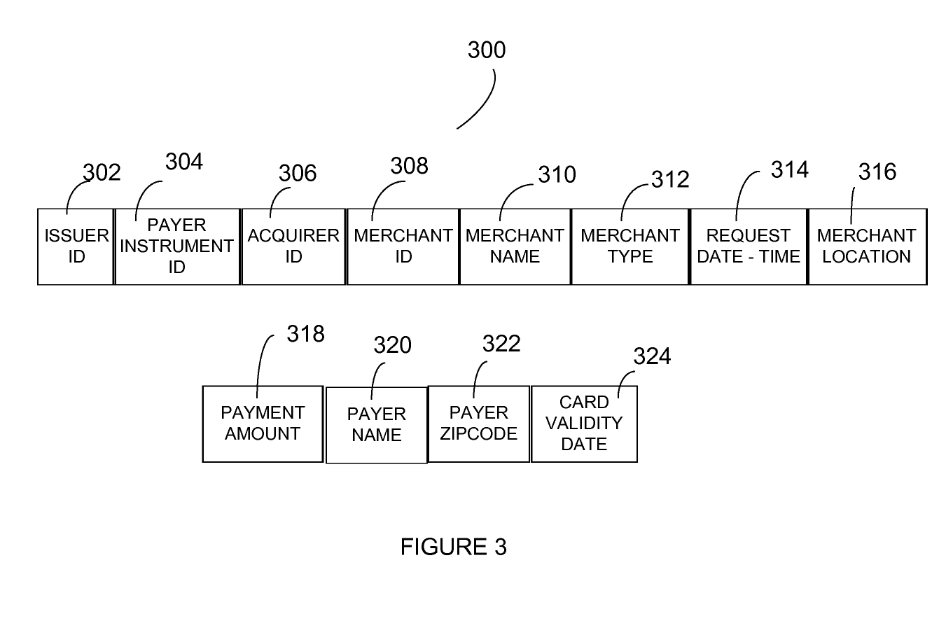

As previously described with reference to FIG. 1, the issuer routing system 134 of CNS 104 transmits the payment transaction information to the card issuer system 102, over link 110. Then, the card network system 104 awaits for an approval or disapproval of the payment transaction by the card issuer system 102. Now, referring to FIG. 3, an example, payment transaction information packet 300 is described.

Now, referring to FIG. 3, an example payment transaction information packet 300 is described. The payment transaction information packet 300 may have a plurality of fields of data. For example, the payment transaction information packet 300 may have an issuer ID 302, payer instrument ID 304, acquirer ID 306, merchant ID 308, merchant name 310, merchant type 312, request date-time 314, merchant location 216, payment amount 318, payer name 320, payer zip code 322 and instrument validity date 322 fields. As one skilled in the art appreciates, payment instrument information packet 300 may have additional fields of data. In some examples, some of the field data related to the payer and issuer may be stored in a data store in the payment instrument.

As one skilled in the art appreciates, one or more fields of data contained in the payment transaction information packet 300 may correspond to or relevant to one or more fields of data stored in the issuer table 200 and payer table 240. For example, payer instrument ID 304 may correspond to specific instrument ID 202 and instrument ID 242 stored in the issuer table 200 and payer table 240. Merchant type 312 may be relevant to type of merchant 260 field in the payer table 240. Merchant location 316 field may relevant to GEO location 258 field in the payer table 240. Request date-time 314 field may be relevant to date and time 252 field, duration 254 and sleep time 256 field of the payer table 240. Payment amount 318 may be relevant to value per 250 field of the payer table.

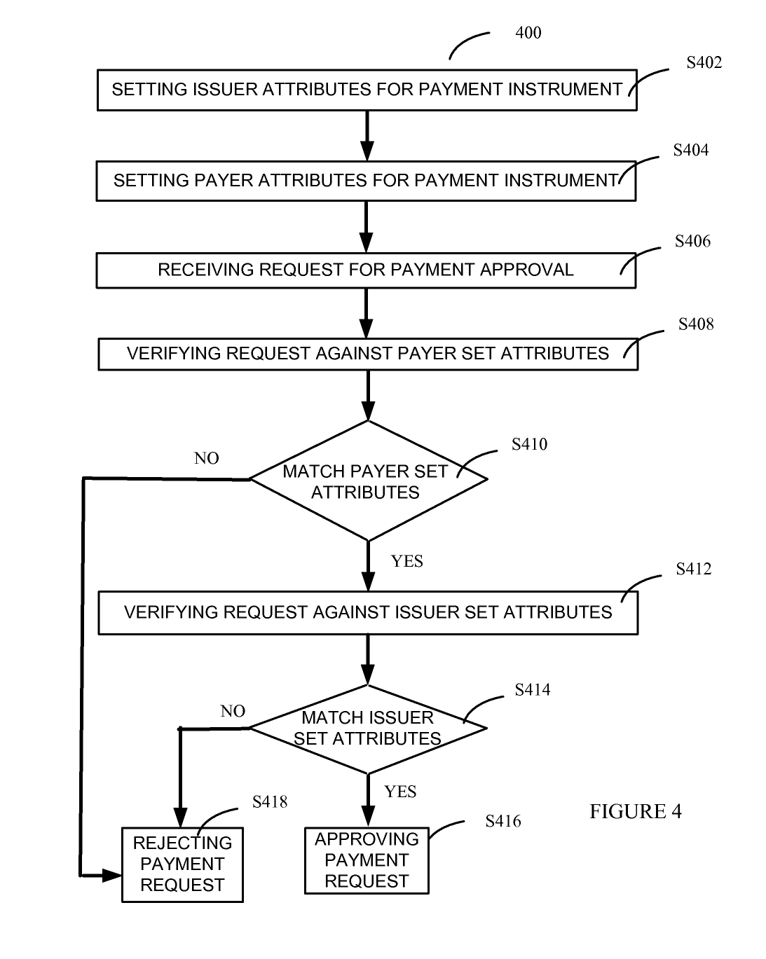

In some examples, a magnetic strip data store may be affixed to the payment instrument. In some examples, other types of memory devices may be affixed to the payment instrument. In some examples, the payment instrument may be a virtual instrument, with corresponding issuer data and payer data stored in a data store corresponding to the virtual instrument. In some examples, one or more fields of data may be physically displayed or printed on the payment instrument and the merchant or the payer may have to enter the data manually. In yet another example, some of the fields of data may not be physically present on the payment instrument and only the payer knows about the data corresponding to those fields of data. As an example, the zipcode of the payer may not be present on the payment instrument and the payer manually enters the data corresponding to the zipcode, at the instrument reader system or computing device, at the point of sale of the goods and services. Now, referring to FIG. 4, an example flow diagram 400 to set up a payment instrument and process a payment request for the payment instrument is described.

Referring to FIG. 4, flow diagram 400, in block 5402, issuer attributes for a payment instrument is set. For example, an issuer may assign a instrument identification number for the payment instrument. Additionally, the issuer may set one or more attributes for the payment instrument. For example, a row corresponding to the instrument identification number may be set in the issuer table 200 as described with reference to FIG. 2A. As previously described with reference to FIGS. 2 and 2A, the CMS 114 may set the corresponding row in the issuer table 200 and store the updated issuer table 200 in the CMS data store 116.

In block 5404, payer attributes for payment instrument is set. For example, a payer may set one or more payer attributes for the corresponding payment instrument. For example, a row corresponding to the instrument identification number of the payer may be set in the payer table 240 as described with reference to FIG. 2B. As previously described with reference to FIGS. 2 and 2B, the PCM 118 may set the corresponding row in the payer table 240 and store the updated payer table 240 in the PCM data store 134.

In one example, payer configuration module 140 may communicate with the payer computer, over link 122. For example, the payer configuration module 140 may communicate to the PC communication module 138 which may in turn communicate with the PCM configuration module 146. PCM configuration module may present one or more input screen to the payer on a display device of the payer computer 120. One or more input screens may be used to receive one or more payer set attributes. For example, the input provided by the payer to the payer computer 120 may be communicated to the PCM 118 over link 122. One or more attributes as provided by the payer is updated and stored in the payer table 240, in the row that corresponds to the instrument identification of the payer.

In block 5406, a request for payment approval is received. In some examples the request for payment approval may include a payment transaction information packet 300 as described with reference to FIG. 3. As previously described, the request for payment approval may be received by the CIPS 124 of the acquirer system 106, which is routed to the corresponding card network system 104. For example, the card network system 104 may decode a portion of the payment transaction information packet 300 and determine the issuer ID. The card network system 104 then routes the request for approval of a payment to the corresponding issuer system 102, based on the information contained in the issuer routing table 134 that corresponds to the specific issuer ID. The request for payment approval is received sent over link 110.

In one example, the request for payment approval is received by the CMS 114. The CMS 114 may further route the request to the PCM 118 over link 106. In some examples, the request for payment approval may be received by both CMS 114 and PCM 118. For example, the PCM 118 may received the request for payment approval over link 154.

In block 5408, the request for payment approval is verified against payer set attributes. For example, the instrument ID of payment instrument for the received request for payment approval is first extracted from the payment transaction information packet 300. Then, based on the instrument ID for the payment instrument, various attributes of the request for payment approval is compared against the payer set attributes. As an example, various information contained in the payment transaction information packet 300 of the request is compared against corresponding attributes stored in the payer table row that corresponds to the instrument identification number. In one example, the active status of the payment instrument is first checked, for example, if the active status in column 244 is set to enable or disable. If the status of the payment instrument is set to disable, the PCM 118 may return a message to the CMS 114 indicating that the payment request should be denied or disapproved. In some examples, no other payer set attributes will be checked if the active field is set to disable. If the status of the payment instrument is set to enable, then the requested payment information is compared against other attributes set by the payer to generate a message indicative of approval or disapproval. For example, various fields of the payment transaction information packet 300 may be checked against attributes set by the payer, for a match.

For example, payer instrument ID 304 may be used to identify specific instrument ID 242 stored in the payer table 240. Then, one or more attributes of the payment information packet 300 may be compared with associated fields of data corresponding to the instrument ID 242 field that matches with the payer instrument ID 304. For example, merchant type 312 field may be used to compare with type of merchant 260 field in the payer table 240. Merchant type 312 field may be used to compare with the type of merchant 260 field in the payer table 240. Merchant location 316 field may be compared with GEO location 258 field in the payer table 240. Request date-time 314 field may be compared against date and time 252 field, duration 254 and sleep time 256 field of the payer table 240 to confirm that a payment transaction is permitted during the time period when the request for payment approval was generated. Payment amount 318 may be compared with value per 250 field of the payer table to confirm the payment amount 318 is within the permitted value per transaction. If the payment amount 318 is within the permitted value per transaction, the total value 248 field may be compared with the payment amount 318 to confirm that the approval of the payment transaction will not exceed the total value 248 set in the payer table 240. Additionally, the # of transactions 246 field may be checked to see if this specific payment request approval is within the permitted number of transactions by the payer. If this specific payment request approval is within the permitted number of transactions, the # of transactions 246 field may be incremented by one. In some examples, upon approval of the payment transaction, the # of transactions 246 field may be incremented by one. Further, the total value 248 field may also be updated by subtracting the value of the transaction from the total value 248 field to reflect the updated total value 248 of the payer table 240.

In block S410, if the requested payment information, for example, as received in one or more fields of the payment transaction information packet 300 matches or permitted per the payer set attributes, a message indicative of approval is sent to the CMS 114. If the requested payment information does not match the payer set attributes, a message indicative of disapproval is sent to the CMS 114.

For example, payer instrument ID 304 may be used to identify specific instrument ID 202 stored in the issuer table 200. Then, one or more attributes of the payment information packet 300 may be compared with associated fields of data corresponding to the instrument ID 202 field that matches with the payer instrument ID 304. For example, payer name 320 field may be compared with name 204 of the payer for a match. Instrument validity date 322 may be compared with validity date 210 field for a match. Payer zipcode 320 field may be compared with zip code 218 field of the issuer table 200. Payment amount 318 may be compared with available credit 208 field of the issuer table to confirm the payment amount 318 is within the available credit. If the payment amount 318 is within the available credit 208, upon approval, the available credit 208 field may be updated by subtracting the payment amount 318 from the previous available credit amount

If in block S410, the message indicative of disapproval is generated, in block S418, a message rejecting payment request is sent to the card network system 104. In one example, the CMS 114 sends a message indicating disapproval of the payment request to the card network system 104.

If in block S410, the message indicative of approval is generated, in block S412, the request for payment approval is verified against issuer set attributes. For example, the instrument identification of payment instrument for the received request for payment approval is first extracted. Then, based on the instrument identification for the payment instrument, various fields of the payment transaction information packet 300 may be checked against attributes set by the issuer, for a match. As an example, various fields of data of the payment transaction information packet 300 is compared against the attributes stored in the issuer table row that corresponds to the instrument identification number.

In block 5412, if the requested payment information for example, as received in one or more fields of the payment transaction information packet 300 matches the issuer set attributes, in block 5416, a message approving payment request is sent to the card network system 104. For example, the CMS 114 sends a message approving the payment request to the card network system 104. If the requested payment information does not match the issuer set attributes, in block 5418, a message indicative of disapproval is sent to the card network system 104.

As one skilled in the art appreciates, payment approval systems operate on a rigid time frame to exchange messages between various systems. In some examples, the operations performed to verify request against payer set attributes and operations performed to verify request against issuer set attributes may be performed in parallel or independent of each other. In some examples, it may be preferable to send any messages to the card network system from the CMS 114. For example, if a payment request is disapproved by the PCM 118, it may be beneficial in some examples to pass the disapproval message through CMS 114 so that CMS 114 is aware of all transactions related to a payment instrument.

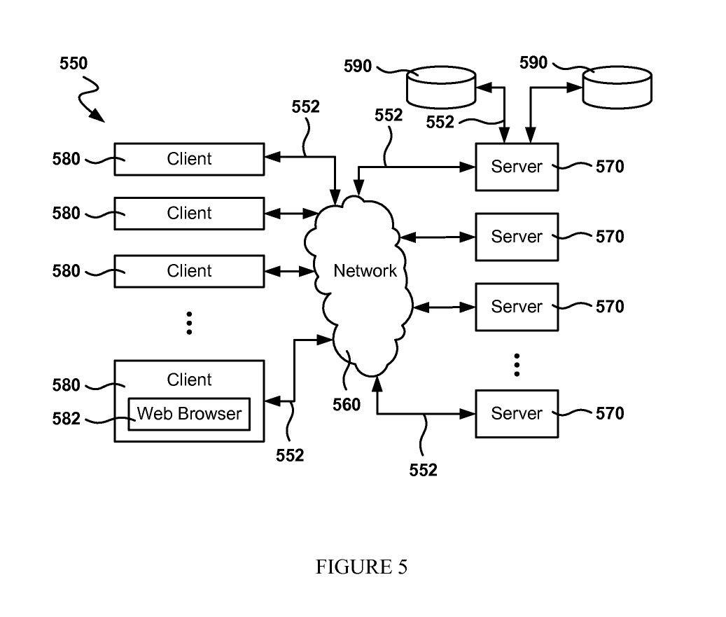

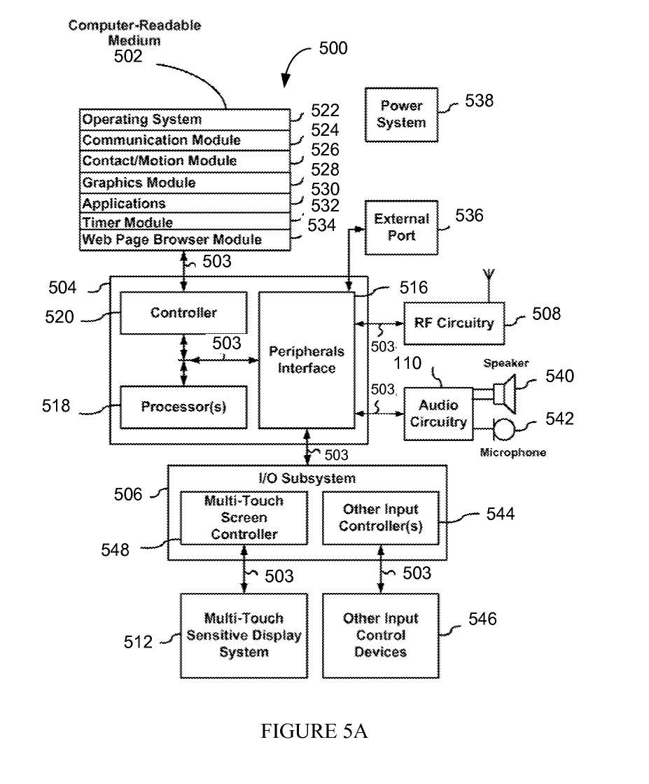

FIG. 5 illustrates an example network environment 550 suitable for implementing embodiments of the invention. Network environment 550 includes a network 560 coupling one or more servers 570 and one or more clients 580 to each other. In particular embodiments, network 560 is an intranet, an extranet, a virtual private network (VPN), a local area network (LAN), a wireless LAN (WLAN), a wide area network (WAN), a metropolitan area network (MAN), a portion of the Internet, another network, or a combination of two or more such networks 560.

One or more links 552 couple a server 570 or a client 580 to network 560. In particular embodiments, one or more links 552 each includes one or more wireline, wireless, or optical links 552. In particular embodiments, one or more links 552 each includes an intranet, an extranet, a VPN, a LAN, a WLAN, a WAN, a MAN, a portion of the Internet, or another link 552 or a combination of two or more such links 552.

Each server 570 may be a stand-alone server or may be a distributed server spanning multiple computers or multiple datacenters. Servers 570 may be of various types, such as, for example and without limitation, web server, news server, mail server, message server, advertising server, file server, application server, exchange server, database server, or proxy server. Each server 570 may include hardware, software, embedded logic components, or a combination of two or more such components for carrying out the appropriate functionalities implemented or supported by server 570. For example, a web server is generally capable of hosting websites containing web pages or particular elements of web pages. More specifically, a web server may host HTML files or other file types, or may dynamically create or constitute files upon a request, and communicate them to clients 580 in response to HTTP or other requests from clients 580. A mail server is generally capable of providing electronic mail services to various clients 580. A database server is generally capable of providing an interface for managing data stored in one or more data stores. In one example, payment instrument processing system 100 of this disclosure may be implemented on one or more servers 570. In some example, some of the modules of the payment instrument processing system 100 may be implemented on one server 570 and other modules of the payment instrument processing system 100 may be implemented on another server 570.

In particular embodiments, one or more data storages 590 may be communicatively linked to one or more severs 570 via one or more links 552. Data storages 590 may be used to store various types of information. The information stored in data storages 590 may be organized according to specific data structures. In particular embodiments, each data storage 590 may be a relational database. Particular embodiments may provide interfaces that enable servers 570 or clients 580 to manage, e.g., retrieve, modify, add, or delete, the information stored in data storage 590.

In particular embodiments, each client 580 may be an electronic device including hardware, software, or embedded logic components or a combination of two or more such components and capable of carrying out the appropriate functionalities implemented or supported by client 580. For example and without limitation, a client 580 may be a desktop computer system, a notebook computer system, a netbook computer system, a handheld electronic device, or a mobile telephone. Further, each client 580 may be a computing device, such as a desktop computer or a work station, or a mobile device, such as a notebook computer, a network computer, a tablet computer or a smart telephone. In some embodiments, client 580 may be similar to payer computer 120.

In particular embodiments, a client 580 may have a web browser 582, such as MICROSOFT INTERNET EXPLORER, GOOGLE CHROME, or MOZILLA FIREFOX, and may have one or more add-ons, plug-ins, or other extensions. A user at client 580 may enter a Uniform Resource Locator (URL) or other address directing the web browser 582 to a server 570, and the web browser 582 may generate a Hyper Text Transfer Protocol (HTTP) request and communicate the HTTP request to server 570. In some embodiments, an application, for example, an access control system may communicate with the web browser 582 and send commands to the web browser 582. The web browser 582 may generate a Hyper Text Transfer Protocol (HTTP) request and communicate the HTTP request to server 570. Server 570 may accept the HTTP request and communicate to client 580 one or more Hyper Text Markup Language (HTML) files responsive to the HTTP request. Client 580 may render a web page based on the HTML files from server 570 for presentation to the user. In some embodiments, the client 580 may send commands to an application, for example, the payment instrument processing system 100 so that the payment instrument processing system 100 processes the commands and displays the results of the command. The present disclosure contemplates any suitable web page files. As an example and not by way of limitation, web pages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web page encompasses one or more corresponding web page files (which a browser may use to render the web page) and vice versa, where appropriate.

Web browser 582 may be adapted for the type of client 580 where the web browser executes. For example, a web browser residing on a desktop computer may differ (e.g., in functionalities) from a web browser residing on a mobile device. A user of the access control system may access the website via web browser 582 or via a link between the access control system and the web browser 582.

Computing Device Architecture

FIG. 5A is a block diagram of one embodiment of a computing device architecture of a computing device 500, for example, computing device architecture of a client 580. The computing device 500 generally includes one or more computer-readable mediums 502, a processing system 504, an Input/Output (I/O) subsystem 506, radio frequency (RF) circuitry 508 and audio circuitry 510. These components may be coupled by one or more communication buses or signal lines 503. The device 500 can be any portable electronic device, including but not limited to a handheld computer, a tablet computer, a mobile phone, a media player, personal digital assistant (PDA) and the like, including a combination of two or more of these items.

It should be apparent that the architecture shown in FIG. 5A is only one example of an architecture for the computing device 500, and that the device 500 could have more or fewer components than shown, or a different configuration of components. The various components shown in FIG. 5A can be implemented in hardware, software or a combination of both hardware and software, including one or more signal processing and/or application specific integrated circuits. The RF circuitry 508 is used to send and receive information over a wireless link or network to one or more other devices and includes well-known circuitry for performing this function, including but not limited to an antenna system, an RF transceiver, one or more amplifiers, a tuner, one or more oscillators, a digital signal processor, a CODEC chipset, memory, etc. In some embodiments, the RF circuitry 508 is capable of establishing and maintaining communications with other devices using one or more communications protocols, including but not limited to time division multiple access (TDMA), code division multiple access (CDMA), global system for mobile communications (GSM), Enhanced Data GSM Environment (EDGE), wideband code division multiple access (W-CDMA), Wi-Fi (such as IEEE 802.11a, IEEE 802.11b, IEEE 802.11g and/or IEEE 802.11n), Bluetooth, Wi-MAX, voice over Internet Protocol (VoIP), a protocol for email, instant messaging, and/or a short message service (SMS), or any other suitable communication protocol, including communication protocols not yet developed as of the filing date of this document.

The RF circuitry 508 and the audio circuitry 510 are coupled to the processing system 504 via the peripherals interface 516. The interface 516 includes various known components for establishing and maintaining communication between peripherals and the processing system 504. The audio circuitry 510 is coupled to an audio speaker 540 and a microphone 542 and includes known circuitry for processing voice signals received from interface 516 to enable a user to communicate in real-time with other users. In some embodiments, the audio circuitry 510 includes a headphone jack (not shown). Voice and data information received by the RF circuitry 508 and the audio circuitry 510 (e.g., in speech recognition or voice command applications) is sent to one or more processors 518 via the interface 516. The one or more processors 518 are configurable to process various data formats for one or more applications 530.

Note that the term “data” includes but is not limited to text, graphics, Web pages, JAVA applets, emails, instant messages, voice, digital images or video, widgets, MP3s, etc., which can be used by one or more applications 530 stored on medium 502 (e.g., Web browser, email, etc.). In some embodiments, the device 100 is capable of uploading and downloading various data from the Internet over a wireless network or an external port 536, such as files, songs, digital images, videos, emails, widgets, instant messages and the like.

The peripherals interface 516 couples the input and output peripherals of the device to the processor 518 and the computer-readable medium 502. The one or more processors 518 communicate with the one or more computer-readable mediums 502 via a controller 520. The computer-readable medium 502 can be any device or medium that can store code and/or data for use by the one or more processors 518. The medium 502 can include a memory hierarchy, including but not limited to cache, main memory and secondary memory. The memory hierarchy can be implemented using any combination of RAM (e.g., SRAM, DRAM, DDRAM), ROM, FLASH, magnetic and/or optical storage devices, such as disk drives, magnetic tape, CDs (compact disks) and DVDs (digital video discs). The medium 502 may also include a transmission medium for carrying information-bearing signals indicative of computer instructions or data (with or without a carrier wave upon which the signals are modulated). For example, the transmission medium may include a communications network, including but not limited to the Internet (also referred to as the World Wide Web), intranet(s), Local Area Networks (LANs), Wide Local Area Networks (WLANs), Storage Area Networks (SANs), Metropolitan Area Networks (MAN) and the like.

The one or more processors 518 run various software components stored in the medium 502 to perform various functions for the device 500. In some embodiments, the software components include an operating system 522, a communication module (or set of instructions) 524, a contact/motion module (or set of instructions) 526, a graphics module (or set of instructions) 528, one or more applications (or set of instructions) 530, a timer module (or set of instructions) 532 and a Web browser module (or set of instructions) 534.

The operating system 522 (e.g., Darwin, RTXC, LINUX, UNIX, OS X, WINDOWS, or an embedded operating system such as VxWorks) includes various procedures, sets of instructions, software components and/or drivers for controlling and managing general system tasks (e.g., memory management, storage device control, power management, etc.) and facilitates communication between various hardware and software components.

The communication module 524 facilitates communication with other devices over one or more external ports 536 and includes various software components for handling data received the RF circuitry 508 and/or the external port 536. The external port 536 (e.g., USB, FireWire™, etc.) is adapted for coupling directly to other devices or indirectly over a network (e.g., the Internet, wireless LAN, etc.).

The graphics module 528 includes various known software components for rendering, animating and displaying graphical objects on a display surface of the multi-touch-sensitive display system 512. Note that the term “graphical object” includes any object that can be displayed to a user, including without limitation text, web pages, icons, digital images, animations and the like.

The one or more applications 530 can include any applications installed on the device 500, including without limitation, a browser, address book, contact list, email, instant messaging, word processing, keyboard emulation, widgets, JAVA-enabled applications, encryption, digital rights management, voice recognition, voice replication, location determination capability (such as that provided by the global positioning system (GPS)), a music player (which plays back recorded music stored in one or more files, such as MP3 or AAC files), etc.

In some embodiments, the device 500 may include the functionality of an MP3 player. In some embodiments, the device 500 may include one or more optional optical sensors (not shown), such as CMOS or CCD image sensors, for use with imaging applications.

The contact/motion module 526 includes various software components for performing various tasks associated with the touch-sensitive display system 112.

The I/O subsystem 506 is coupled to the touch-sensitive display system 512 and one or more other physical control devices 514 (e.g., pushbuttons, switches, dials, LEDs, etc.) for controlling or performing various functions, such as power control, speaker volume control, ring tone loudness, keyboard input, scrolling, hold, menu, screen lock, clearing and ending communications and the like. The touch-sensitive display 512 communicates with the processing system 504 via the touch sensitive screen controller 548 which includes various components for processing user input (e.g., scanning hardware). The one or more other input controllers 544 receives/sends electrical signals from/to the other input or control devices 546. The other input/control devices 546 may include physical buttons (e.g., push buttons, rocker buttons, etc.), dials, slider switches, sticks, and so forth.

The touch-sensitive display 512 displays visual output to the user. The visual output may include text, graphics, video, and any combination thereof. Some or all of the visual output may correspond to user-interface objects. The touch-sensitive display 512 may also accept input from the user based on haptic and/or tactile contact. The touch-sensitive display 512 forms a touch-sensitive surface that accepts user input. The touch-sensitive display 512 and the touch screen controller 548 (along with any associated modules and/or sets of instructions in the medium 502) detects contact (and any movement or release of the contact) on the touch-sensitive display 512 and converts the detected contact into interaction with user-interface objects, such as one or more soft keys, that are displayed on the touch screen when the contact occurs. In an exemplary embodiment, a point of contact between the touch-sensitive display 512 and the user corresponds to one or more digits of the user. The touch-sensitive display 512 may use LCD (liquid crystal display) technology, or LPD (light emitting polymer display) technology, although other display technologies may be used in other embodiments. The touch-sensitive display 512 and touch screen controller 120 may detect contact and any movement or release thereof using any of a plurality of touch sensitivity technologies, including but not limited to capacitive, resistive, infrared, and surface acoustic wave technologies, as well as other proximity sensor arrays or other elements for determining one or more points of contact with the multi touch-sensitive display 512. The user may make contact with the multi touch-sensitive display 512 using any suitable object or appendage, such as a stylus, pen, finger, and so forth.

In some embodiments, in addition to the touch screen, the device 500 may include a touchpad (not shown) for activating or deactivating particular functions. In some embodiments, the touchpad is a touch-sensitive area of the device that, unlike the touch screen, does not display visual output. The touchpad may be a touch-sensitive surface that is separate from the touch-sensitive display 512 or an extension of the touch-sensitive surface formed by the touch-sensitive display 512.

The device 500 also includes a power system 538 for powering the various hardware components. The power system 538 can include a power management system, one or more power sources (e.g., battery, alternating current (AC)), a recharging system, a power failure detection circuit, a power converter or inverter, a power status indicator (e.g., a light emitting diode (LED)) and any other components typically associated with the generation, management and distribution of power in portable devices.

In some embodiments, the peripherals interface 516, the one or more processors 518, and the memory controller 520 may be implemented on a single chip, such as the processing system 504. In some other embodiments, they may be implemented on separate chips.

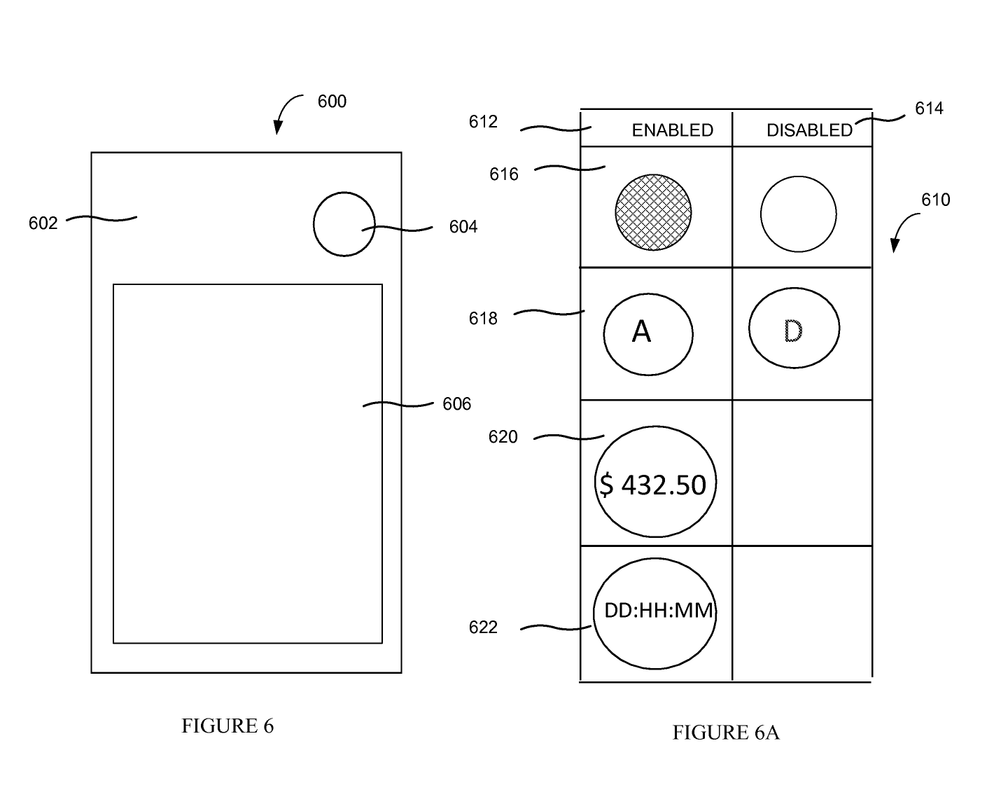

FIG. 6 shows an example payer computer 600. Payer computer 600 may be similar to payer computer 120 of FIG. 1. The payer computer 600 includes a display device 602. The display device 602 may include a payer instrument status indicator 604 area and a payer input 604 area. The payer instrument status indicator 604 area indicates the instrument status, for example, whether the payment instrument active field is enabled or disabled. Payer input 604 area may be used to present one or more fields to the payer to receive one or more inputs from the payer. In some examples, an authentication information may have to be entered by the payer to access the payer computer 600. After authentication, payer may be able to set one or more payer attributes using the payer computer 600.

FIG. 6A shows an example table 610 with some possible depiction of the payment instrument status indicator 604. For example, column 612 depicts possible representation of status indicators if the instrument is enabled. Column 614 depicts possible representation of status indicators if the instrument is disabled. Various rows of table 610 depict possible representation of icons indicative of the status of the instrument. As an example, referring to row 616, if the instrument is enabled, an icon as depicted in column 612 may be displayed as the payment instrument status indicator 604. If on the other hand, the instrument is disabled, an icon as depicted in column 614 may be displayed as the payment instrument status indicator 604. In some examples, the icon may be color coded. In some examples, the icons may have one or more characters displayed, for example, as shown in row 618.

In some examples, if the instrument is enabled, the payment instrument status indicator 604 may include additional information related to the payment instrument. As an example, referring to row 620, the payment instrument status indicator 604 may indicate total value available for the payment instrument. In yet another example, referring to row 622, the payment status indicator 604 may indicate duration for which the payment instrument will be still active. In this example, the duration is shown in days:hours:minutes format.

As one skilled in the art appreciates, payment instrument status indicator 604 may also be configured to be an active icon, whereby the payment instrument status indicator 604 may be selected or activated to perform additional operations. As an example, if the display device 602 is a touch sensitive display, touching the payment instrument status indicator 604 may launch one or more programs to interact with the payer.

In some examples, the payer computer 600 may be similar to device 500, as described with reference to FIG. 5A. As one skilled in the art appreciates, the payer computer 600 may be a mobile device and the payer may be able to selectively switch or set the payment instrument active field just before initiating a payment transaction. In this way, possibility for misuse of the payment instrument may be minimized. In some examples, additional payer attributes may be selectively set by the payer, in anticipation of a payment transaction. For example, payer may set a geography attribute based on where the payment instrument is anticipated to be used. As one skilled in the art appreciates, geography attribute may extend to a city, state, country or group of countries.

Although some of the systems and methods have been described with reference to a credit card processing systems, as one skilled in the art appreciates, systems that may be used to process other payment instruments like checks, bank drafts, electronic payment instruments, direct debit mechanisms to financial institutions and other types of payment instructions may be implemented by suitably modifying one or more embodiments of this disclosure.

The foregoing descriptions of specific embodiments of the present invention are presented for purposes of illustration and description. They are not intended to be exhaustive or to limit the invention to the precise forms disclosed. Rather, it should be appreciated that many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

Herein, reference to a computer-readable storage medium encompasses one or more non-transitory, tangible computer-readable storage media possessing structure that may store a computer program or data. As an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a Secure Digital card, a Secure Digital drive, or another suitable computer-readable storage medium or a combination of two or more of these, where appropriate. Herein, reference to a computer-readable storage medium excludes any medium that is not eligible for patent protection under 35 U.S.C. §101.

One or more embodiments of the present invention can also be fabricated as computer readable code on a non-transitory computer readable medium. Herein, reference to software may encompass one or more applications, bytecode, one or more computer programs, one or more executables, one or more instructions, logic, machine code, one or more scripts, or source code, and vice versa, where appropriate.

The present disclosure encompasses all changes, substitutions, variations, alterations, and modifications to the example embodiments herein that a person having ordinary skill in the art would comprehend.

What is claimed is:

1. A method for processing payment request for a payment instrument, the method comprising:
setting issuer attributes for the payment instrument;
setting payer attributes for the payment instrument;
receiving request for payment approval;
verifying request against payer set attributes;
verifying request against issuer set attributes; and
generating an approval message if payment request matches both payer set attributes and issuer set attributes, wherein at least one method operation is executed by a processor.

2. The method as recited in claim 1, further including generating a disapproval message if either payer set attributes or issuer set attributes do not match the payment request.

3. The method as recited in claim 1, wherein, setting payer attributes further including:
setting an instrument active field, wherein if the instrument active field is set to disable, then generating a disapproval message, without checking any other attributes set by the payer.

4. The method as recited in claim 3, wherein, if the instrument active field is set to enable, then checking other attributes set by the payer.

5. The method of claim 4, wherein checking other attributes includes checking whether the payment transaction was received during a predefined period set by the payer.

6. The method of claim 4, wherein checking other attributes includes checking whether a payment amount is within a preset value per transaction.

7. The method of claim 4, wherein checking other attributes includes checking whether payment request originated from a predefined geographic location.

8. The method of claim 4, wherein checking other attributes includes checking whether payment request originated from a predefined merchant type.

9. The method of claim 6, wherein checking other attributes includes checking whether the payment amount is within a preset total value of all payment transactions.

10. The method of claim 6, wherein checking other attributes includes checking whether the transaction is within a preset total permitted transactions.

11. The method of claim 4, further including displaying setting of instrument active field on a display device.

12. The method of claim 11, wherein if the instrument active field is set to enable, displaying one or more payer attributes on the display device.

13. A system to process payment request for a payment instrument, the system comprising:
a card management system to set issuer attributes for the payment instrument in a CMS data store; and
a payer controlled module to set payer attributes for the payment instrument in a PCM data store, wherein:
the system receives a request for payment approval;
the payer controlled module verifies request against payer set attributes;
the card management system verifies request against issuer set attributes; and
the card management system generates an approval message if payment request matches both payer set attributes and issuer set attributes.

14. The system as recited in claim 13, wherein the card management system generates a disapproval message if either payer set attributes or issuer set attributes do not match the payment request.

15. The system as recited in claim 13, wherein, one of the payer attribute further including an instrument active field, wherein if the instrument active field is set to disable, then a disapproval message is generated, without checking any other attributes set by the payer.

16. The system, as recited in claim 15, wherein, if the instrument active field is set to enable, then checking other attributes set by the payer.

17. The system of claim 16, wherein checking other attributes includes checking whether the payment transaction was received during a predefined period set by the payer.

18. The system of claim 16, wherein checking other attributes includes checking whether a payment amount is within a preset value per transaction.

19. The system of claim 16, wherein checking other attributes includes checking whether payment request originated from a predefined geographic location.

20. The system of claim 16, wherein checking other attributes includes checking whether payment request originated from a predefined merchant type.

21. The system of claim 18, wherein checking other attributes includes checking whether the payment amount is within a preset total value of all payment transactions.

22. The system of claim 18, wherein checking other attributes includes checking whether the transaction is within a preset total permitted transactions.

23. The system of claim 16, further including displaying setting of instrument active field on a display device.

24. The system of claim 23, wherein if the instrument active field is set to enable, displaying one or more payer attributes on the display device.

25. A non-transitory computer readable medium having program instructions that when executed by a computing device implements a method for processing a payment request for a payment instrument, said method comprising:
setting issuer attributes for the payment instrument;
setting payer attribute for the payment instrument;
receiving request for payment approval;
verifying request against payer set attributes;
verifying request against issuer set attributes; and
generating an approval message if payment request matches both payer set attributes and issuer set attributes, wherein at least one method operation is executed by a processor.

26. The non-transitory computer readable medium as recited in claim 25, further including generating a disapproval message if either payer set attributes or issuer set attributes do not match the payment request.

27. The non-transitory computer readable medium as recited in claim 25, wherein, setting payer attribute further including:
setting an instrument active field, wherein if the instrument active field is set to disable, then generating a disapproval message, without checking any other attributes set by the payer.

28. The non-transitory computer readable medium as recited in claim 27, wherein, if the instrument active field is set to enable, then checking other attributes set by the payer.

29. The non-transitory computer readable medium of claim 28, wherein checking other attributes includes checking whether the payment transaction was received during a predefined period set by the payer.

30. The non-transitory computer readable medium of claim 29, wherein checking other attributes includes checking whether a payment amount is within a preset value per transaction.

31. The non-transitory computer readable medium of claim 29, wherein checking other attributes includes checking whether payment request originated from a predefined geographic location.

32. The non-transitory computer readable medium of claim 29, wherein checking other attributes includes checking whether payment request originated from a predefined merchant type.

33. The non-transitory computer readable medium of claim 30, wherein checking other attributes includes checking whether the payment amount is within a preset total value of all payment transactions.

34. The non-transitory computer readable medium of claim 30, wherein checking other attributes includes checking whether the transaction is within a preset total permitted transactions.

35. The non-transitory computer readable medium of claim 28, further including displaying setting of instrument active field on a display device.

36. The system of claim 35, wherein if the instrument active field is set to enable, displaying one or more payer attributes on the display device.
